(19) United States
(12) Patent Application Publication
(10) Pub. No.: US 2024/0296631 A1
(43) Pub. Date: Sep. 5, 2024

(54) VR SCENE SWITCHING METHOD AND DEVICE, VR HEAD-MOUNTED EQUIPMENT AND STORAGE MEDIUM

(71) Applicant: GOERTEK INC., Shandong (CN)

(72) Inventors: Feng CHEN, Shandong (CN); Zengsen CUI, Shandong (CN)

(73) Assignee: GOERTEK INC., Shandong (CN)

(21) Appl. No.: 18/245,702

(22) PCT Filed: Dec. 7, 2021
(86) PCT No.: PCT/CN2021/135896

§ 371 Date: Mar. 16, 2023

(30) Foreign Application Priority Data
Nov. 30, 2021 (CN) 202111442507.9

(51) Int. Cl. G06T 19/00; G06T 13/20

(52) U.S. Cl. CPC G06T 19/006; G06T 13/20

(57) ABSTRACT

A VR scene switching method applied to a VR head-mounted equipment is disclosed. The method is applied to a VR head-mounted equipment equipped with a camera. The VR scene switching method comprises: collecting a real environment picture using the camera, and generating a real scene content added with a scene switching element according to the real environment picture; displaying the real scene content on a display screen of the VR head-mounted equipment; judging whether a control instruction of entering a virtual scene is received; if yes, displaying a transition animation on the display screen of the VR head-mounted equipment, wherein the transition animation comprises a process that a user enters the virtual scene via the scene switching element; and displaying the virtual scene content on the display screen of the VR head-mounted equipment.

### CROSS-REFERENCE TO RELATED APPLICATIONS

This application is a U.S. National-Stage entry under 35 U.S.C. § 371 based on International Application No. PCT/CN2021/135896, filed Dec. 7, 2021 which was published under PCT Article 21(2) and which claims priority to Chinese Application No. 202111442507.9, filed Nov. 30, 2021, which are all hereby incorporated herein in their entirety by reference.

### TECHNICAL FIELD

This application pertains to the field of virtual reality technology, in particular to a VR scene switching method and device, a VR head-mounted equipment and a storage medium.

### BACKGROUND

VR (Virtual Reality) technology involves computer, electronic information, simulation and other technologies, and provides people a sense of environmental immersion by simulating a virtual environment using a computer. With the continuous development of social productivity and science and technology, the demand for VR technology from various industries has been growing.

Usually, when starting to use VR equipment, a model of 3D real world is completely reconstructed first, and then a model of 3D virtual world is rendered. This process requires excessive computing resources, and affects the operation efficiency of VR equipment.

Therefore, how to reduce the computing resource consumption of VR equipment and improve the operation efficiency is currently a technical problem to be solved by those skilled in the art. In addition, other objects, desirable features and characteristics will become apparent from the subsequent summary and detailed description, and the appended claims, taken in conjunction with the accompanying drawings and this background.

### SUMMARY

The object of the present disclosure is to provide a VR scene switching method and device, a storage medium and a VR head-mounted equipment, which can reduce the computing resource consumption of VR equipment and improve the operation efficiency.

To solve the above technical problem, the present disclosure provides a VR scene switching method, which is applied to a VR head-mounted equipment equipped with a camera. The VR scene switching method comprises:
collecting a real environment picture using the camera, and generating a real scene content added with a scene switching element according to the real environment picture;
displaying the real scene content on a display screen of the VR head-mounted equipment;
judging whether a control instruction of entering a virtual scene is received;
if yes, displaying a transition animation on the display screen of the VR head-mounted equipment, wherein the transition animation comprises a process that a user enters the virtual scene via the scene switching element; and
displaying the virtual scene content on the display screen of the VR head-mounted equipment.

Optionally, after collecting real environment picture using the camera, it further comprises:
judging whether a door exists in a current environment according to the real environment picture;
if the door exists, putting the scene switching element in the real scene content at a position of the door, wherein the scene switching element comprises a virtual door obtained by 3D rendering.

Optionally, before displaying a transition animation on the display screen of the VR head-mounted equipment, it further comprises:
displaying a door opening animation of opening the virtual door;
displaying part of the virtual scene content in an area where the virtual door is opened.

Optionally, after judging whether a door exists in the current environment according to the real environment picture, it further comprises:
if the door does not exist, creating the virtual door and a virtual wall, and setting the virtual door and the virtual wall as the scene switching elements added into the real scene content.

Optionally, after displaying the real scene content on a display screen of the VR head-mounted equipment, it further comprises:
performing corresponding 3D calculation and 3D rendering on the model corresponding to the virtual scene content so as to preload the virtual scene content.

Optionally, after displaying the virtual scene content on the display screen of the VR head-mounted equipment, it further comprises:
turning off the camera and stopping an operation of generating the real scene content.

Optionally, after displaying the virtual scene content on the display screen of the VR head-mounted equipment, it further comprises:
judging whether a control instruction of exiting the virtual scene is received;
if yes, displaying an exit animation on the display screen of the VR head-mounted equipment, wherein the exit animation comprises a process that a user exits the virtual scene via the scene switching element.

The present disclosure also provides a VR scene switching device, which is applied to a VR head-mounted equipment equipped with a camera. The VR scene switching device comprises:
a real scene generation module for collecting a real environment picture using the camera, and generating a real scene content added with a scene switching element according to the real environment picture;
a judgment module for judging whether a control instruction of entering a virtual scene is received; and
a display screen for displaying the real scene content before receiving the control instruction of entering the virtual scene, and for displaying a transition animation after receiving the control instruction of entering the virtual scene, and displaying the virtual scene content after the displaying of the transition animation is completed;
wherein the transition animation comprises a process that a user enters the virtual scene via the scene switching element.

The present disclosure also provides a storage medium having computer executable instructions stored therein, and when the computer executable instructions are loaded and executed by a processor, steps of the VR scene switching methods as stated above are implemented.

The present disclosure also provides a VR head-mounted equipment comprising a camera, a memory and a processor, the memory has a computer program stored therein, and when the processor calls the computer program in the memory, steps of the VR scene switching methods as stated above are implemented.

The present disclosure provides a VR scene switching method, applied to a VR head-mounted equipment equipped with a camera, the VR scene switching method comprises: collecting a real environment picture using the camera, and generating a real scene content added with a scene switching element according to the real environment picture; displaying the real scene content on a display screen of the VR head-mounted equipment; judging whether a control instruction of entering a virtual scene is received; if yes, displaying a transition animation on the display screen of the VR head-mounted equipment, wherein the transition animation comprises a process that a user enters the virtual scene via the scene switching element; and displaying the virtual scene content on the display screen of the VR head-mounted equipment.

In the present disclosure, the camera is used to collect the real environment picture, and then the real scene content added with a scene switching element is generated based on the real environment picture, so that the VR head-mounted equipment can display the real scene content added with the scene switching element. If the control instruction of entering the virtual scene is received, in the present disclosure, the smooth transition between the real scene and the virtual scene can be realized by displaying the transition animation from the real scene to the virtual scene. In the above process, it is not necessary to completely reconstruct the real scene content, which can reduce the computing resource consumption of VR equipment and improve the operating efficiency. The present disclosure also provides a VR scene switching device, a storage medium and a VR head-mounted equipment, which have the above beneficial effects and will not be repeated here.

### BRIEF DESCRIPTION OF DRAWINGS

The present invention will hereinafter be described in conjunction with the following drawing figures, wherein like numerals denote like elements, and:

FIG. 1 is a flow chart of a VR scene switching method according to an embodiment of the present disclosure;

FIG. 2 is a schematic diagram of the state of a user wearing a VR head-mounted equipment according to an embodiment of the present disclosure;

FIG. 3 is a flow chart of a dynamically drawn method for switching between virtual scenes and real scenes according to an embodiment of the present disclosure;

FIG. 4 is a schematic diagram of the effect of switching between virtual scenes and real scenes according to an embodiment of the present disclosure; and

FIG. 5 is a schematic diagram of the structure of a VR scene switching device according to an embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The technical solutions in embodiments of the present disclosure will be described clearly and completely below with reference to the drawings in the embodiments of the present disclosure. Obviously, the embodiments as described below are merely part of, rather than all, embodiments of the present disclosure. Based on the embodiments of the present disclosure, any other embodiment obtained by a person of ordinary skill in the art without paying any creative effort shall fall within the protection scope of the present disclosure.

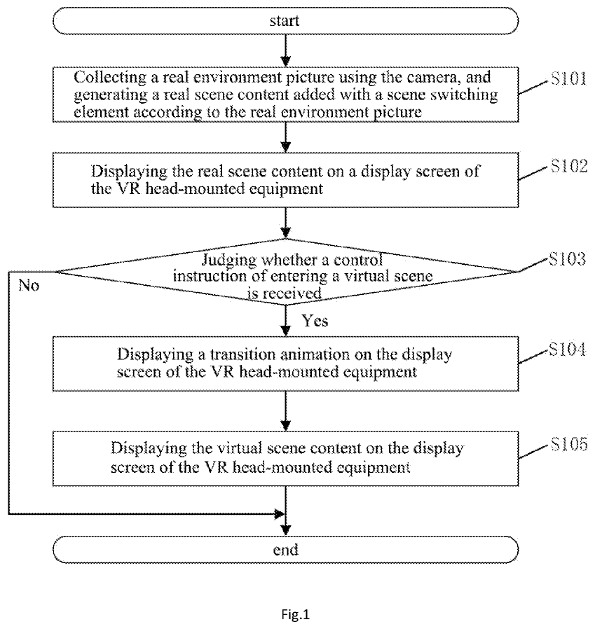

Please refer to FIG. 1, which is a flow chart of a VR scene switching method according to an embodiment of the present disclosure.

The VR scene switching method may specifically comprise the following steps:

S101: collecting a real environment picture using the camera, and generating a real scene content added with a scene switching element according to the real environment picture.

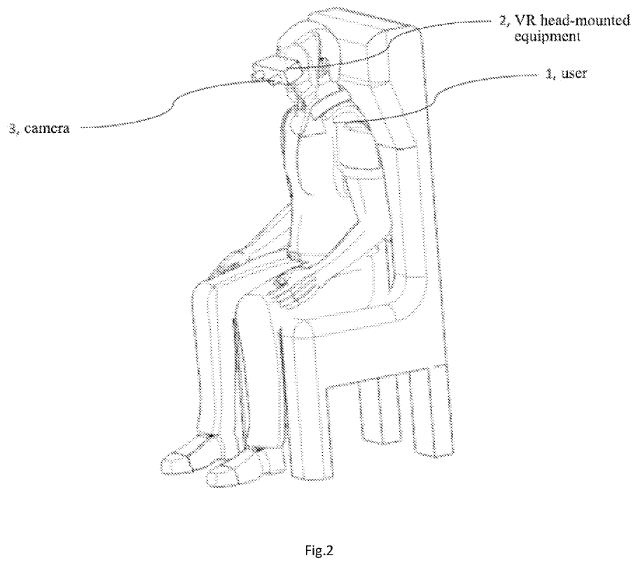

This embodiment can be applied to a VR head-mounted equipment, which may be equipped with a camera. This embodiment does not limit the number, shooting directions and installation positions of cameras. Please refer to FIG. 2, which is a schematic diagram of the state of a user wearing a VR head-mounted equipment according to an embodiment of the present disclosure. As shown in FIG. 2, 1 is the user, 2 is the VR head-mounted equipment, and 3 is the camera on the VR head-mounted equipment. The VR head-mounted equipment may comprise at least two cameras, and these two cameras are located in the front of the corresponding positions of the user's left and right eyes. The parameters of the cameras can be the same as those of the human eye.

In the present disclosure, on the basis of obtaining the real environment picture, a real scene content added with a scene switching element is generated according to the real environment picture. The scene switching element is an element rendered by the VR head-mounted equipment, and is used to realize the display switching between the real scene and the virtual scene. For example, the scene switching element may be a virtual object rendered from a door, window, etc. In this embodiment, the scene switching element may be added to a specific position of the real environment picture to obtain a real scene content.

S102: displaying the real scene content on a display screen of the VR head-mounted equipment.

After obtaining the real scene content, the real scene content may be directly displayed on the display screen of the VR head-mounted equipment. In this embodiment, there is an operation of collecting real environment pictures so as to update the real scene content and thus realize the updating of the real scene content displayed by the VR head-mounted equipment along with the rotation of the user's head, thereby improving the user experience.

Further, after displaying the real scene content on the display screen of the VR head-mounted equipment, the corresponding 3D calculation and 3D rendering may be performed on a model corresponding to the virtual scene content, so as to preload the virtual scene content. The above solution of preloading the virtual scene content can improve the efficiency of entering the virtual scene.

S103: judging whether a control instruction of entering a virtual scene is received; if yes, proceeding to S104.

The control instruction of entering the virtual scene is an instruction for controlling the display content of the VR head-mounted equipment to switch from the real scene content to the virtual scene content. The above control instruction may be an instruction generated by the user triggering the buttons of the VR head-mounted equipment, or an instruction sent by a smart terminal (such as a mobile phone or a tablet) connected to the VR head-mounted equipment. If the control instruction of entering the virtual scene is not received, the real scene content may continue to be displayed on the display.

S104: displaying a transition animation on the display screen of the VR head-mounted equipment.

This step is based on having received the control instruction of entering the virtual scene. The transition animation may be displayed on the display screen of the VR head-mounted equipment, so that the real content on the display screen can smoothly transition from the real scene content to the virtual scene content, thereby avoiding the dramatic change of light intensity caused by sudden scene switching, and improving the immersion of the VR head-mounted equipment.

Further, the above transition animation may comprise a process that a user enters the virtual scene via the scene switching element (such as a door, window, pipe and other objects).

S105: displaying the virtual scene content on the display screen of the VR head-mounted equipment.

After the transition animation is displayed, in this embodiment, the virtual scene content can be displayed on the display screen of the VR head-mounted equipment, so that the user can fully enter the virtual world. Further, after the virtual scene content is displayed on the display screen of the VR head-mounted equipment, the camera may be turned off and the operation of generating the real scene content may be stopped.

In this embodiment, the camera is used to collect the real environment picture, and then the real scene content added with a scene switching element is generated based on the real environment picture, so that the VR head-mounted equipment can display the real scene content added with the scene switching element. If the control instruction of entering the virtual scene is received, in this embodiment, the smooth transition between the real scene and the virtual scene can be realized by displaying the transition animation from the real scene to the virtual scene. In the above process, it is not necessary to completely reconstruct the real scene content, which can reduce the computing resource consumption of VR equipment and improve the operating efficiency.

As a feasible implementation mode, after the virtual scene content is displayed on the display screen of the VR head-mounted equipment, there may also be an operation to exit the virtual scene. The specific implementation process is as follows: judging whether a control instruction of exiting the virtual scene is received; if yes, displaying an exit animation on the display screen of the VR head-mounted equipment. The exit animation comprises a process that a user exits the virtual scene via the scene switching element. Further, when entering the virtual scene, the camera may enter a turned off or sleeping state. After receiving the control instruction to exit the virtual scene, the camera may be turned on or awakened to perform the relevant operations of S101 to S102 in the corresponding embodiment of FIG. 1.

As a further introduction to the embodiment corresponding to FIG. 1, the above scene switching element may comprise a virtual door obtained by 3D rendering, and the transition animation may be an animation that the user enters the virtual scene from the real scene via the virtual door. Therefore, after collecting a real environment picture using the camera, it may be judged whether a door exists in a current environment according to the real environment picture; if the door exists, the scene switching element in the real scene content is put at a position of the door. In the above way, the virtual door is used to mask the door of the real world, which improves the interactivity of VR equipment.

Further, before displaying a transition animation on the display screen of the VR head-mounted equipment, a door opening animation of opening the virtual door may also be displayed, and part of the virtual scene content in an area where the virtual door is opened may also be displayed.

Further, after judging whether a door exists in the current environment according to the real environment picture, if the door does not exist, the virtual door and a virtual wall may be created, and the virtual door and virtual wall can be set as the scene switching element added into the real scene content.

The flow described in the above embodiments will be described below through the embodiments in practical applications.

When VR head-mounted equipment are used, the real content includes the process of switching from a real scene to a virtual scene, and then redrawing the virtual world scene. In the above process, the switching between the real scene and the virtual scene is too sudden. For example, a user wants to experience a VR game at home, when he wears the VR device, a dark scene or a UI interface will appear first, and then the game interface appears. In the above process, the scenes are switched sharply and the immersion feeling is not strong.

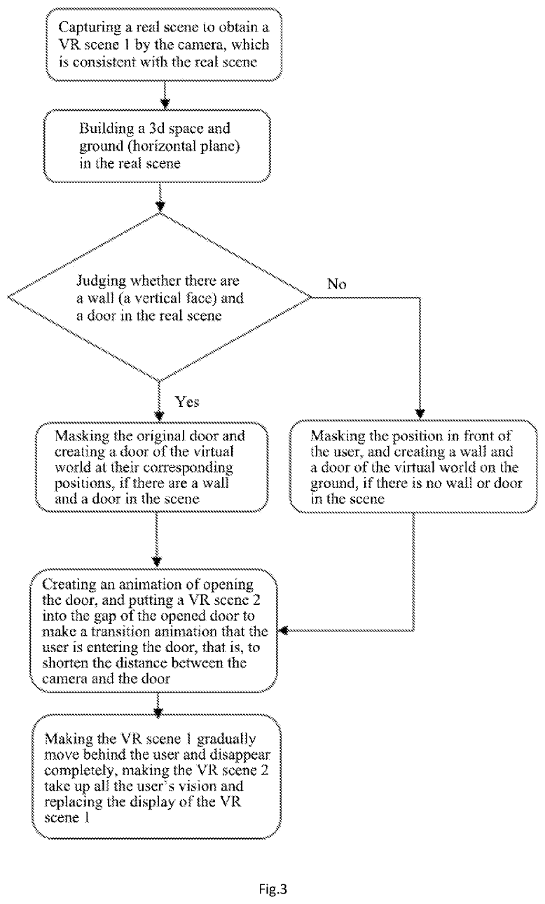

Please refer to FIG. 3, which is a flow chart of a dynamically drawn method for switching between virtual scenes and real scenes according to an embodiment of the present disclosure. The camera captures a real scene to obtain a VR scene 1, which is consistent with the real scene. A 3D space and ground (horizontal plane) are built in the real scene. It is judged whether there are a wall (a vertical face) and a door in the real scene. If there are a wall and a door in the scene, the original door is masked and a door of the virtual world is created at their corresponding positions. If there is no wall or door in the scene, the position in front of the user is masked, and a wall and a door of the virtual world are created on the ground. An animation of opening the door is created, and a VR scene 2 is put into the gap of the opened door to make a transition animation that the user is entering the door, that is, to shorten the distance between the camera and the door. The VR scene 1 gradually moves behind the user and disappears completely. The VR Scene 2 takes up all the user's vision and replaces the display of the VR Scene 1.

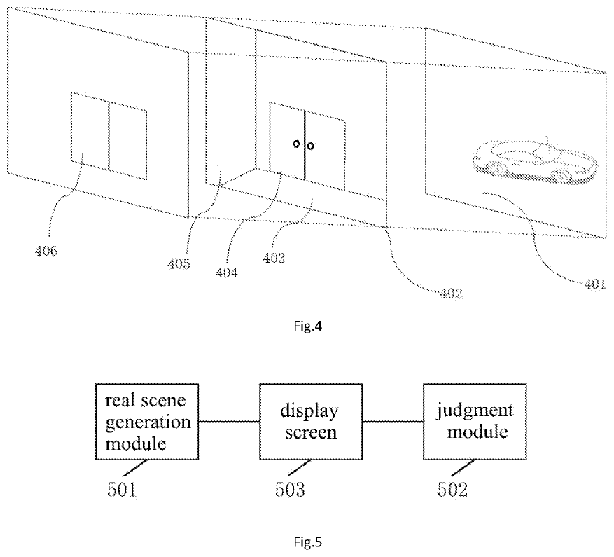

Please refer to FIG. 4, which is a schematic diagram of the effect of switching between virtual scene and real scene according to an embodiment of the present disclosure. In FIG. 4, 401 represents the VR scene 2 (such as a game scene), 402 represents the VR scene 1 (such as a reality scene reconstructed by video), 403 represents the ground, 404 represents a door, 405 represents a wall, and 406 represents a 3D rendered virtual door. When the user wears the VR head-mounted equipment to observe the surrounding world, the VR head-mounted equipment presents the VR scene 1 to the user by a real-time binocular video. The VR scene 1 is consistent with the user's real world. Presenting the scene by the above method does not require 3D calculation and rendering, and the virtual scene is generated fast and displayed with good quality. The wall and door in the surrounding environment are confirmed. After their locations are determined, a preset 3D rendered door is used to replace the position of original door, and mask the position of original door. After the door is opened, the user's view is zoomed in to the position of the door, and at this time, the VR scene 2 can be seen from the position where the door is opened. In this example, the VR scene 2 is the three-dimensional world of VR game. After the user completely passes through the door, the objects in VR scene 1 and the 3D rendered object door move behind the user and are completely out of the user's view. At this time, the VR scene 1 and the 3D rendered object door are closed, and the user eventually enters the VR scene 2 completely. If the user looks back, VR scene 1 has disappeared. In FIG. 4, the user sees a car and can interact with it, such as entering the cab or walking around and observing the car.

The above embodiments can realize the switching process between real scenes and virtual scenes with good logic and rationality, that is, the user opens a door (such as the door of fairyland) in the real world to enter the virtual world. Compared with some existing methods of completely reconstructing the 3D real world, in this embodiment, the video reconstruction is fast with high quality and good picture quality. In addition, the 3D rendered objects used in this solution are elements that have been made in advance, and do not need to consume too much computing resources.

Please refer to FIG. 5, which is a schematic diagram of the structure of a VR scene switching device according to an embodiment of the present disclosure. The device can be applied to a VR head-mounted equipment equipped with a camera. The VR scene switching device comprises:
a real scene generation module 501 for collecting a real environment picture using the camera, and generating a real scene content added with a scene switching element according to the real environment picture;
a judgment module 502 for judging whether a control instruction of entering a virtual scene is received; and
a display screen 503 for displaying the real scene content before receiving the control instruction of entering the virtual scene, and for displaying a transition animation after receiving the control instruction of entering the virtual scene, and displaying the virtual scene content after the displaying of the transition animation is completed;
wherein the transition animation comprises a process that a user enters the virtual scene via the scene switching element.

In this embodiment, the camera is used to collect the real environment picture, and then the real scene content added with a scene switching element is generated based on the real environment picture, so that the VR head-mounted equipment can display the real scene content added with a scene switching element. If the control instruction of entering the virtual scene is received, in this embodiment, the smooth transition between the real scene and the virtual scene can be realized by displaying the transition animation from the real scene to the virtual scene. In the above process, it is not necessary to completely reconstruct the real scene content, which can reduce the computing resource consumption of VR equipment and improve the operating efficiency.

Further, it further comprises:
a door blocking module for, after collecting real environment picture using the camera, judging whether a door exists in a current environment according to the real environment picture; if the door exists, putting the scene switching element in the real scene content at a position of the door, wherein the scene switching element comprises a virtual door obtained by 3D rendering.

Further, it further comprises:
a door opening processing module for, before displaying a transition animation on the display screen of the VR head-mounted equipment, displaying a door opening animation of opening the virtual door; and for displaying part of the virtual scene content in an area where the virtual door is opened.

Further, it further comprises:
a scene switching element setting module for, after judging whether a door exists in the current environment according to the real environment picture, if the door does not exist, creating the virtual door and a virtual wall, and setting the virtual door and the virtual wall as the scene switching elements added into the real scene content.

Further, it further comprises:
a preloading module for, after displaying the real scene content on a display screen of the VR head-mounted equipment, performing corresponding 3D calculation and 3D rendering on the model corresponding to the virtual scene content so as to preload the virtual scene content.

Further, it further comprises:
a camera control module for, after displaying the virtual scene content on the display screen of the VR head-mounted equipment, turning off the camera and stopping an operation of generating the real scene content.

Further, it further comprises:
a scene exit module for, after displaying the virtual scene content on the display screen of the VR head-mounted equipment, judging whether a control instruction of exiting the virtual scene is received; if yes, displaying an exit animation on the display screen of the VR head-mounted equipment, wherein the exit animation comprises a process that a user exits the virtual scene via the scene switching element.

Since the embodiments of the device part correspond to the embodiments of the method part, please refer to the description of the embodiments of the method part for details, which will not be repeated here.

The present disclosure also provides a storage medium having a computer program stored thereon. When the computer program is executed, the steps provided in the above embodiments can be implemented. The storage medium may comprise: USB flash disk, mobile hard disk, Read Only Memory (ROM), Random Access Memory (RAM), magnetic disc or optical disc and other media that can store program code.

The present disclosure also provides a VR head-mounted equipment, which can comprise a memory and a processor. The memory has a computer program stored therein. When the processor calls the computer program in the memory, the steps provided in the above embodiments can be implemented. Of course, the VR head-mounted equipment may also comprise various network interfaces, power supplies and other components.

Each embodiment in the specification is described in a progressive manner. Each embodiment focuses on the differences from other embodiments. The same and similar parts of the embodiments can be referred to each other. As for the device according to an embodiment, since it corresponds to the method according to an embodiment, the description is relatively simple. Please refer to the description of the method section for relevant parts. It should be noted that, for those skilled in the art, certain improvements and modifications can be made to the present disclosure without departing from the principles of the present disclosure, and these improvements and modifications also fall within the protection scope of the claims of the present disclosure.

It should also be noted that, relational terms such as first and second used herein are only to distinguish one entity or operation from another, and do not necessarily require or imply that there is such actual relationship or order among those entities or operations. Moreover, the terms “comprise”, “include” or any other variants are intended to cover non-exclusive inclusion, so that the process, method, article or apparatus including a series of elements may not only include those elements, but may also include other elements not stated explicitly, or elements inherent to the process, method, articles or apparatus. Without more limitations, an element defined by the phrase “comprising a . . . ” does not exclude the case that there are other same elements in the process, method, article or apparatus including the element.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A VR scene switching method, applied to a VR head-mounted equipment equipped with a camera, wherein the VR scene switching method comprises:
collecting a real environment picture using the camera, and generating a real scene content added with a scene switching element according to the real environment picture;
displaying the real scene content on a display screen of the VR head-mounted equipment;
judging whether a control instruction of entering a virtual scene is received;
if yes, displaying a transition animation on the display screen of the VR head-mounted equipment, wherein the transition animation comprises a process that a user enters the virtual scene via the scene switching element; and
displaying the virtual scene content on the display screen of the VR head-mounted equipment.

2. The VR scene switching method according to claim 1, wherein after collecting real environment picture using the camera, it further comprises:
judging whether a door exists in a current environment according to the real environment picture;
if the door exists, putting the scene switching element in the real scene content at a position of the door, wherein the scene switching element comprises a virtual door obtained by 3D rendering.

3. The VR scene switching method according to claim 2, wherein before displaying a transition animation on the display screen of the VR head-mounted equipment, it further comprises:
displaying a door opening animation of opening the virtual door;
displaying part of the virtual scene content in an area where the virtual door is opened.

4. The VR scene switching method according to claim 2, wherein after judging whether a door exists in the current environment according to the real environment picture, it further comprises:
if the door does not exist, creating the virtual door and a virtual wall, and setting the virtual door and the virtual wall as the scene switching element added into the real scene content.

5. The VR scene switching method according to claim 1, wherein after displaying the real scene content on a display screen of the VR head-mounted equipment, it further comprises:
performing corresponding 3D calculation and 3D rendering on a model corresponding to the virtual scene content so as to preload the virtual scene content.

6. The VR scene switching method according to claim 1, wherein after displaying the virtual scene content on the display screen of the VR head-mounted equipment, it further comprises:
turning off the camera and stopping an operation of generating the real scene content.

7. The switching method of the VR scene according to claim 1, wherein after displaying the virtual scene content on the display screen of the VR head-mounted equipment, it further comprises:
judging whether a control instruction of exiting the virtual scene is received;
if yes, displaying an exit animation on the display screen of the VR head-mounted equipment, wherein the exit animation comprises a process that a user exits the virtual scene via the scene switching element.

8. A VR scene switching device, applied to a VR head-mounted equipment equipped with a camera, wherein the VR scene switching device comprises:
a real scene generation module for collecting a real environment picture using the camera, and generating a real scene content added with a scene switching element according to the real environment picture;
a judgment module for judging whether a control instruction of entering a virtual scene is received; and
a display screen for displaying the real scene content before receiving the control instruction of entering the virtual scene, and for displaying a transition animation after receiving the control instruction of entering the virtual scene, and displaying the virtual scene content after the displaying of the transition animation is completed;
wherein the transition animation comprises a process that a user enters the virtual scene via the scene switching element.

9. A VR head-mounted equipment comprising a camera, a memory and a processor, wherein the memory has a computer program stored therein, and when the processor calls the computer program in the memory, steps of the VR scene switching method according to claim 1 are implemented.

10. (canceled)

11. The switching method of the VR scene according to claim 2, wherein after displaying the virtual scene content on the display screen of the VR head-mounted equipment, it further comprises:
judging whether a control instruction of exiting the virtual scene is received;
if yes, displaying an exit animation on the display screen of the VR head-mounted equipment, wherein the exit animation comprises a process that a user exits the virtual scene via the scene switching element.

12. The switching method of the VR scene according to claim 3, wherein after displaying the virtual scene content on the display screen of the VR head-mounted equipment, it further comprises:
judging whether a control instruction of exiting the virtual scene is received;
if yes, displaying an exit animation on the display screen of the VR head-mounted equipment, wherein the exit animation comprises a process that a user exits the virtual scene via the scene switching element.

13. The switching method of the VR scene according to claim 4, wherein after displaying the virtual scene content on the display screen of the VR head-mounted equipment, it further comprises:
judging whether a control instruction of exiting the virtual scene is received;
if yes, displaying an exit animation on the display screen of the VR head-mounted equipment, wherein the exit animation comprises a process that a user exits the virtual scene via the scene switching element.

14. The switching method of the VR scene according to claim 5, wherein after displaying the virtual scene content on the display screen of the VR head-mounted equipment, it further comprises:
judging whether a control instruction of exiting the virtual scene is received;
if yes, displaying an exit animation on the display screen of the VR head-mounted equipment, wherein the exit animation comprises a process that a user exits the virtual scene via the scene switching element.

15. The switching method of the VR scene according to claim 6, wherein after displaying the virtual scene content on the display screen of the VR head-mounted equipment, it further comprises:
judging whether a control instruction of exiting the virtual scene is received;
if yes, displaying an exit animation on the display screen of the VR head-mounted equipment, wherein the exit animation comprises a process that a user exits the virtual scene via the scene switching element.

16. The VR head-mounted equipment according to claim 9, wherein after collecting real environment picture using the camera, it further comprises:
judging whether a door exists in a current environment according to the real environment picture;
if the door exists, putting the scene switching element in the real scene content at a position of the door, wherein the scene switching element comprises a virtual door obtained by 3D rendering.

17. The VR head-mounted equipment according to claim 9, wherein before displaying a transition animation on the display screen of the VR head-mounted equipment, it further comprises:
displaying a door opening animation of opening the virtual door;
displaying part of the virtual scene content in an area where the virtual door is opened.

18. The VR head-mounted equipment according to claim 9, wherein after judging whether a door exists in the current environment according to the real environment picture, it further comprises:
if the door does not exist, creating the virtual door and a virtual wall, and setting the virtual door and the virtual wall as the scene switching element added into the real scene content.

19. The VR head-mounted equipment according to claim 9, wherein after displaying the real scene content on a display screen of the VR head-mounted equipment, it further comprises:
performing corresponding 3D calculation and 3D rendering on a model corresponding to the virtual scene content so as to preload the virtual scene content.

20. The VR head-mounted equipment according to claim 9, wherein after displaying the virtual scene content on the display screen of the VR head-mounted equipment, it further comprises:
turning off the camera and stopping an operation of generating the real scene content.

21. The VR head-mounted equipment according to claim 9, wherein after displaying the virtual scene content on the display screen of the VR head-mounted equipment, it further comprises:
judging whether a control instruction of exiting the virtual scene is received;
if yes, displaying an exit animation on the display screen of the VR head-mounted equipment, wherein the exit animation comprises a process that a user exits the virtual scene via the scene switching element.
